(19) United States
(12) Patent Application Publication
(10) Pub. No.: US 2024/0404432 A1
(43) Pub. Date: Dec. 5, 2024

(54) CONVERTIBLE DISPLAY TAGS AND METHODS OF USE THEREOF

(71) Applicant: Derek Pedersen, Greer, SC (US)

(72) Inventor: Derek Pedersen, Greer, SC (US)

(21) Appl. No.: 18/731,964

(22) Filed: Jun. 3, 2024

Related U.S. Application Data
(60) Provisional application No. 63/505,852, filed on Jun. 2, 2023.

(51) Int. Cl. G09F 3/02; G09F 3/06

(52) U.S. Cl. CPC G09F 3/02; G09F 3/06; G09F 2003/027; G09F 2003/0273

(57) ABSTRACT

Articles of manufacture for suspending a hanging product in multiple configurations using a single display tag are disclosed. The display tag can include a body comprising a first aperture at a first end of the body, a second aperture at a second end of the body, and a plurality of flaps located between the first end and the second end. Each of the plurality of flaps can be configured to fold outwardly to an extended position to thereby combine to form an attachment structure that is detachably attachable to a product aperture of a product packaging. The display tag can be configured to rotate about the attachment structure between a first orientation configured to hang from a first object and a second orientation configured to hang from a second object.

### CROSS-REFERENCE TO RELATED APPLICATIONS

This application claims the benefit of, and priority to, U.S. Provisional Patent Application No. 63/505,852, filed Jun. 2, 2023, and entitled “Product Tag with Rotational Hanging Mechanism,” the disclosure of which is incorporated by reference in its entirety as if the same was fully set forth herein.

### TECHNICAL FIELD

This application generally relates to articles of manufacture for hanging products and, more specifically, to rotational display tags for configuring products to hang from different objects.

### BACKGROUND

Hang tags are typically flat structures configured to attach to a first product and hang that first product from a retail display or a second product. Hang tags can be designed or otherwise configured to hang from hanging display structures (e.g., a shelf, a clip strip, a hook) or other structures for displaying products, such as in a store or other retail environment. Hang tags are typically attached to a product with an adhesive or specifically designed to attach to a particular feature of a given container. For example, FIG. 1A illustrates an existing first hang tag 100A that is used to suspend a hanging product 20 (e.g., a specialty item, a promotional item, or any other type of item) from the neck 11 of another product 10, such that the hanging product 20 is presented as a secondary product 20 in a bundle with the other product 10 (also referenced herein as the primary product 10 of the bundle, e.g., a bottle or other container). FIGS. 1B-1D illustrate additional examples of existing hang tags 100 (e.g., the first hang tag 100A, a second hang tag 100B, a third hang tag 100C, and a fourth hang tag 100D) used for suspending hanging products 20 from various locations.

As shown in FIGS. 1A-1C, there are hang tags 100A-100C that use physical features of the hanging product 20, such as the neck of a bottle, to suspend one or more hanging products 20 as secondary products 20 from a corresponding primary product 10 in a bundle configuration.

Alternatively, hang tags can be used to present a hanging product for sale by itself (e.g., not in a bundle configuration). For example, FIG. 1D illustrates an example fourth hang tag 100D that includes an adhesive that is configured to adhere to the hanging product 20 to thereby enable the hanging product 20 to hang from hanging display structures (e.g., a hook, a clip strip) or another retail display apparatus, as non-limiting examples.

Thus, existing hang tags are generally designed to exclusively suspend a hanging product from a hanging display structure as a singular item for sale or to exclusively connect the hanging product to another product for sale as a bundle. However, this can create drawbacks. For example, a merchant wishing to sell a certain product as both a standalone product and as a secondary product in a bundled product offering (e.g., connected to a primary product) is currently required to purchase, store, and use two different types of hang tags. Furthermore, hang tags, and in particular many hang tags for bundling products, are typically designed to be semi-permanently (e.g., permanently until the end customer purchases the product(s) and removes the hang tag) attached to a given product, which can cause further time, effort, and related cost for a merchant to exchange the original hang tag for a different hang tag to accommodate the merchant's intended sales type (e.g., as a standalone product, as part of a product bundle).

Furthermore, a merchant is also typically required to inventory multiple stock-keeping units (SKUs) for the same product simply because different types of hang tags are attached to that product. Stated otherwise, hang tags are often applied to products before the products are received by the merchant, and the merchant's inventory is thus dictated by the type of hang tag attached to a product (e.g., whether it is configured to be displayed as a standalone product or configured to be connected to a primary product for sale as a bundled product offering). This redundancy can lead to an otherwise unnecessary increased inventory of a given product, which can lead to otherwise unnecessary inventory costs (e.g., expenses associated with purchasing, storing, and managing the inventory), and can require merchants to utilize multiple types of hang tags, which can be costly, inefficient, and wasteful.

Therefore, there is a long-felt but unresolved need for a hang tag that enables a product to be displayed and/or grouped for sale in multiple different ways and/or to be hung from multiple different locations.

### BRIEF SUMMARY

Briefly described, aspects of the present disclosure generally relate to hang tags (or display tags) and systems and methods for hanging a product packaging from various locations. A “product packaging,” a “hanging product,” and/or a “secondary product,” as used herein, can refer to any particular item displayed for sale in a retail environment (e.g., displayed via suspension from some location or object, such as via a display tag). Traditionally, the method of displaying a particular product packaging was confined by the hang tag attached to that particular product packaging, as discussed herein. The issues associated with such an arrangement can be solved by the technology disclosed herein.

The disclosed technology can relate to a display tag that can facilitate hanging a given product packaging from various different locations. The display tag can include a body, which can include a first aperture, a second aperture, and one or more flaps. The first aperture and the second aperture can be of different sizes to enable the display tag to hang from different locations. For example, the first aperture can be smaller than the second aperture and can be configured to hang from a hanging display structure (e.g., a peg hook of a pegboard). The second aperture can be larger than the first aperture and can be configured to attach or connect to a different product for presentation and sale as a bundled product offering. For example, the second aperture can be configured to receive at least a portion of a neck of the different product to enable the display tag to hang from the neck of the container (e.g., the neck of a wine bottle).

The one or more flaps can be located between the first aperture and the second aperture. The flaps can fold outwardly from a non-extended position to a fully extended position to form an attachment structure. The attachment structure can extend through a product aperture of the product packaging. Once extended through the product aperture, the first flap and the second flap can fold inwardly to detachably attach the attachment structure to the product packaging. Upon securement to the product packaging, the display tag can be configured to rotate about the attachment structure (and/or about the product aperture) to thereby permit the display tag to be oriented in a first configuration in which the display tag is configured to be suspended via the first aperture or in a second configuration in which the display tag is configured to be suspended via the second aperture. Accordingly, the display tag can be a singular structure that is configured to hang a given product packaging from various locations either as a standalone product or as a secondary product for sale in a bundled product offering.

The disclosed technology includes a display tag. The display tag can comprise a body, and the body can comprise a first aperture located at a first end of the body; a second aperture located at a second end of the body; and a plurality of flaps located between the first end and the second end. Each of the plurality of flaps can be configured to fold outwardly such that the plurality of flaps combine to form an attachment structure that is detachably attachable to a product aperture of a product packaging.

The first end can be opposite the second end.

The first aperture can be smaller than the second aperture. The first aperture can be configured to receive a peg hook. The second aperture can be configured to receive a neck of a container.

The body can have a generally rectangular outer shape.

Each of the plurality of flaps can comprise a distal end and a proximal end. The distal end and the proximal end can be positioned along an imaginary line extending through the first aperture and the second aperture. One of the plurality of flaps can comprise an upper flap configured to partially fold outwardly to create a catch at the proximal end of the upper flap. The catch can be configured to at least partially receive a portion of a hang tag of the product packaging such that the product packaging is suspended from the catch.

Each of the plurality of flaps can comprise a central longitudinal axis that is coincident upon a first imaginary line, a second imaginary line can extend through the first aperture and the second aperture (e.g., through the center of the first aperture and the center of the second aperture) and the first imaginary line can be approximately perpendicular to the second imaginary line.

The attachment structure can define a pivot point about which the display tag can rotate relative to the product packaging.

The display tag can be configured to rotate about the pivot point between a first orientation and a second orientation. The first orientation can comprise the first aperture being located above the product packaging when the product packaging is suspended from the display tag. The second orientation can comprise the second aperture being located above the product packaging when the product packaging is suspended from the display tag.

Each flap of the plurality of flaps can be defined by a portion of material partially cut from the body. The body can include a bridge of material disposed between adjacent flaps of the plurality of flaps. The bridge can have a first side and second side. The plurality of flaps can comprise (i) a first flap extending from a first side of the bridge and configured to fold outwardly along the first side and (ii) a second flap extending from a second side of the bridge and configured to fold outwardly along the second side.

The first flap and the second flap can each be configured to fold outwardly to a fully extended position comprising the first flap or the second flap, respectively, being approximately perpendicular to the body.

The first flap and the second flap can cach be configured to fold outwardly between a non-extended position and the fully extended position. The attachment structure can be configured to extend through the product aperture. The first flap and the second flap can be configured to fold inwardly from the fully extended position to a partially extended position to thereby secure the display tag to the product packaging.

The display tag can be configured to suspend the product packaging via the attachment structure.

Each of the plurality of flaps can be configured to extend from the body and can comprise a distal end and a proximal end. The distal end can be located at a tip of a corresponding flap of the plurality of flaps, and the proximal end can be located at a fold line of the corresponding flap of the plurality of flaps. Each of the plurality of flaps can be configured to fold outwardly along the fold line to thereby diverge the tips away from a central point. Each of the plurality of flaps can be configured to fold inwardly along the fold line to thereby converge the tips at the central point.

The body can comprise cardboard, paper, plastic, metal, polymer, or a combination thereof.

The disclosed technology includes a method comprising folding a plurality of flaps outwardly from a body of a display tag to thereby form an attachment structure. The display tag can comprise (i) a first aperture located at a first end of the body, (ii) a second aperture located at a second end of the body, and (iii) the plurality of flaps. The plurality of flaps can be positioned at a location between the first aperture and the second aperture. The method can include inserting the attachment structure through a packaging aperture of a product packaging. The method can include folding the plurality of flaps to a locked position to thereby affix the display tag to the product packaging. The method can include hanging the product packaging via the display tag by (i) rotating the display tag about the attachment structure to a first orientation in which the first aperture is located above the product packaging and attaching the display tag to a peg hook via the first aperture to thereby suspend the product packaging from the peg hook or (ii) rotating the display tag about the attachment structure to a second orientation in which the second aperture is located above the product packaging and attaching the display tag to a neck of a container via the second aperture to thereby suspend the product packaging from the neck of the container.

The disclosed technology includes an assembly comprising a display tag, a product packaging, and a container. The display tag can comprise a body, and the body can comprise a first aperture located at a first end of the body, a second aperture located at a second end of the body, and a plurality of flaps located between the first end and the second end. The second aperture can be larger than the first aperture. The product packaging can comprise a product aperture. The plurality of flaps can be configured to fold outwardly such that the plurality of flaps combine to form an attachment structure that is detachably attachable to the product aperture of the product packaging, and the plurality of flaps can at least partially extend through the product aperture to thereby attach the display tag to the product packaging. The container can comprise a neck, and the neck can at least partially extend through the second aperture.

The first aperture can be configured to receive at least a portion of a peg hook.

The plurality of flaps can be configured to rotatably attach the display tag to the product packaging.

These and other aspects, features, and benefits of the claimed innovation(s) will become apparent from the following detailed written description of the one or more examples and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more examples and/or aspects of the disclosure and, together with the written description, serve to explain the principles of the disclosure. Wherever possible, the same reference numbers are used throughout the drawings to refer to the same or like elements of the disclosed technology, and wherein:

FIGS. 1A-1D illustrates examples of existing hang tags;

FIG. 2 illustrates an isometric view of an example display tag, in accordance with the disclosed technology;

FIG. 3 illustrates a front view of the example display tag, in accordance with the disclosed technology;

FIG. 4 illustrates an isometric view of the example display tag with flaps in a fully extended position, in accordance with the disclosed technology;

FIG. 5 illustrates an isometric view of an example display tag, in accordance with the disclosed technology;

FIG. 6 illustrates a front view of the example display tag shown in FIG. 5, in accordance with the disclosed technology;

FIG. 7 illustrates an example display tag attaching to a product aperture of a hanging product, in accordance with the disclosed technology;

FIG. 8 illustrates an example display tag in a first orientation, in accordance with the disclosed technology;

FIG. 9 illustrates an example display tag rotating about a pivot point, in accordance with the disclosed technology;

FIG. 10 illustrates an example display tag in a second orientation, in accordance with the disclosed technology;

FIG. 11A illustrates an example display tag attached to a hanging product and suspended from a peg hook via a first aperture for display of the hanging product as a singular product, in accordance with the disclosed technology;

FIG. 11B illustrates an example display tag attached to a hanging product and suspended from a primary product via a second aperture for display of the hanging product and the primary product as a product bundle, in accordance with the disclosed technology;

FIG. 12A illustrates an example display tag attached to a hang tag of a hanging product and in the first orientation, in accordance with the disclosed technology;

FIG. 12B illustrates an example display tag attached to a hang tag of a hanging product and in the second orientation, in accordance with the disclosed technology; and

FIGS. 13A-13D illustrate various example display tags, in accordance with the disclosed technology.

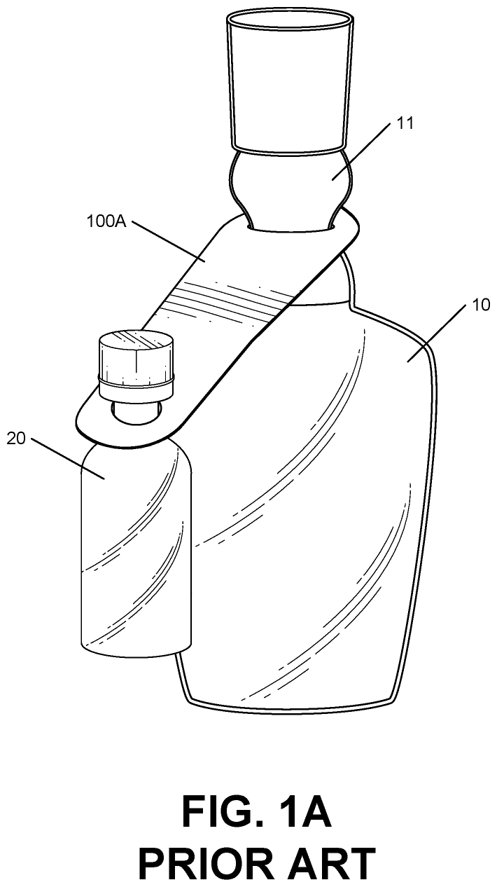

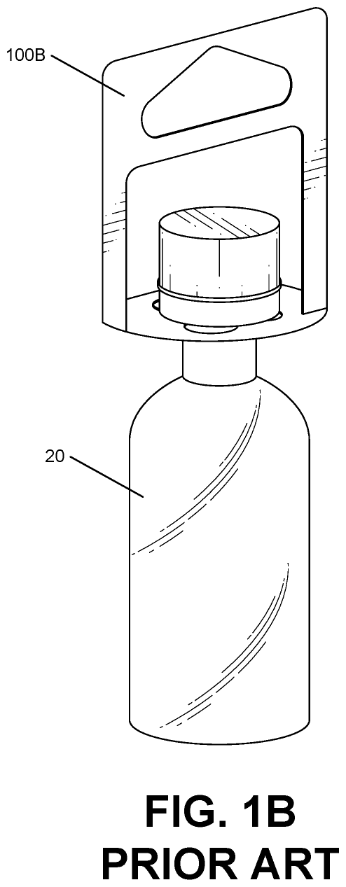

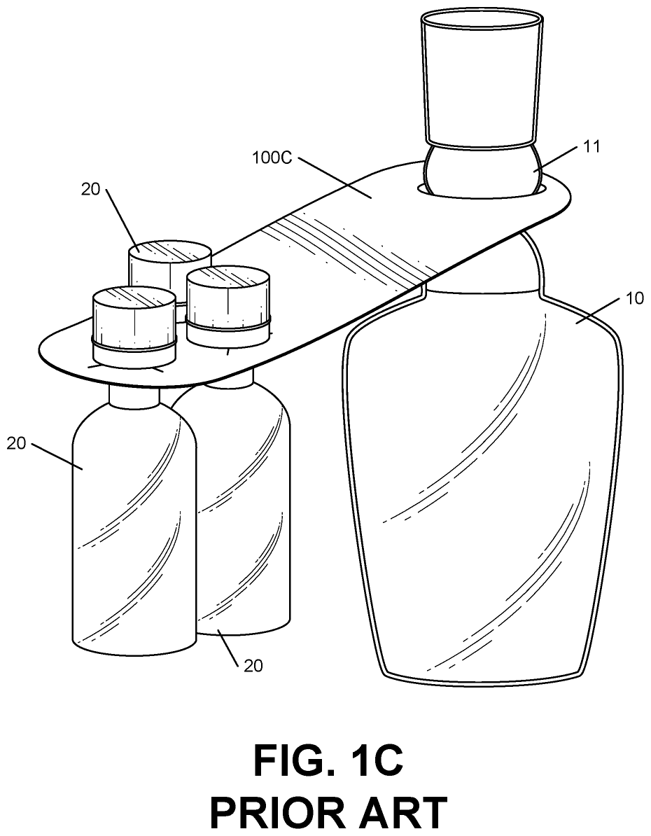

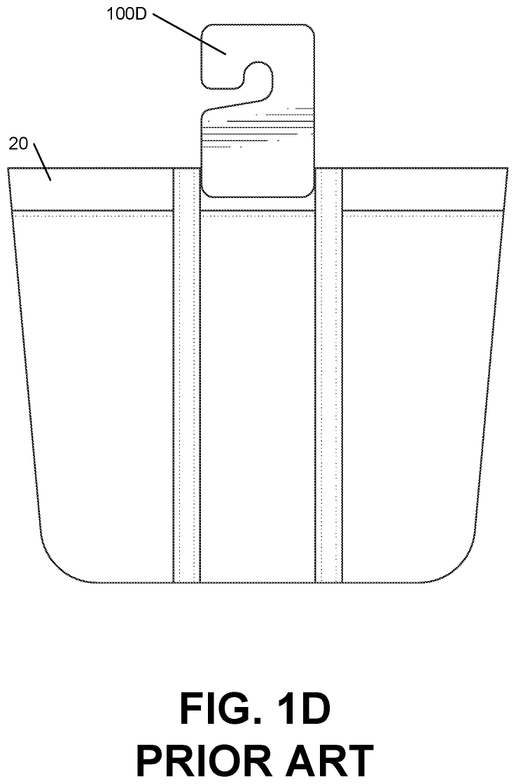

### DETAILED DESCRIPTION

Throughout this disclosure, certain examples are described in relation to display tags for presenting a given product (or product packaging) in multiple configurations, such as a standalone product or as part of a product bundle.

In the following description, numerous specific details are set forth. But it is to be understood that examples of the disclosed technology can be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object merely indicate that different instances of like objects are being referenced, and such terms are not intended to imply that the objects so described should be in a given sequence, either temporally, spatially, in ranking, or in any other manner.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended. The components described hereinafter as making up various elements of the disclosed technology are intended to be illustrative and not restrictive. Any alterations and further modifications of the described or illustrated examples, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to articles of manufacture, systems, and/or methods for hanging a product packaging from various locations. A product packaging can be defined as any particular item displayed for sale in a retail environment. For example, the disclosed technology includes a display tag that can facilitate hanging a single product packaging in various locations and/or configurations. The display tag can include a body, which can include a first aperture, a second aperture, and one or more flaps. The first aperture and the second aperture can have different sizes (e.g., different diameters) such that the display tag can hang from different locations or objects. For example, the first aperture can be smaller than the second aperture and can be sized to receive, and hang from, hanging display structures (e.g., a peg hook of a pegboard), and the second aperture can be larger than the first aperture and can be sized to receive, and hang from, the neck of a container (e.g., the neck of a wine bottle).

The one or more flaps can be located between the first aperture and the second aperture. The flaps can fold outwardly from a non-extended position to a fully extended position to form an attachment structure. The attachment structure can extend through a product aperture of the product packaging. Once extended through the product aperture, the first flap and the second flap can fold inwardly to detachably attach the attachment structure to the product packaging. Upon securement to the product packaging, the display tag can be configured to rotate about the attachment structure (and/or about the product aperture) to thereby permit the display tag to be oriented in a first configuration in which the display tag is configured to be suspended via the first aperture or in a second configuration in which the display tag is configured to be suspended via the second aperture. As such, the display tag can function as a singular structure that is configured to hang a given product packaging from various locations or objects, either as a standalone product or as a secondary product that is part of a product bundle.

### EXAMPLE EMBODIMENTS

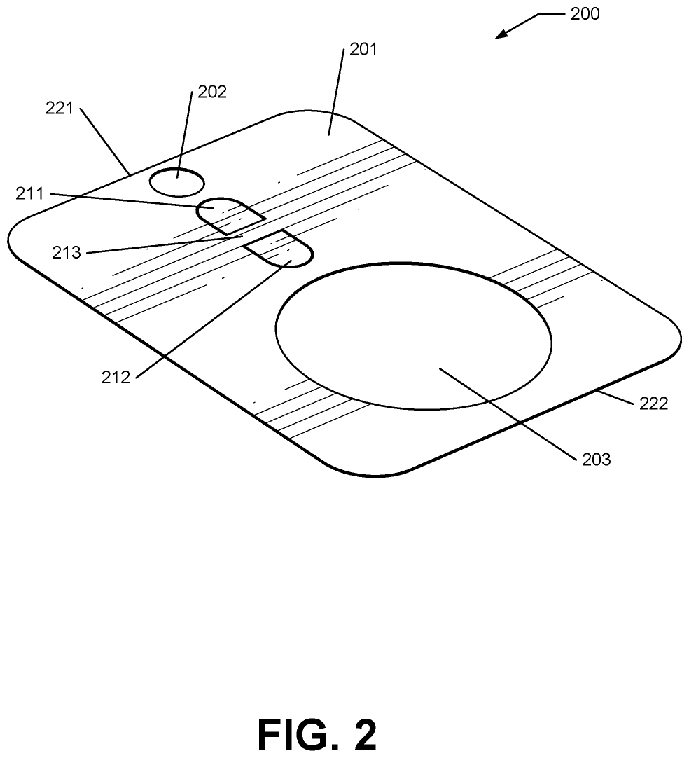

Referring now to the figures, for the purposes of example and explanation of the fundamental processes and components of the disclosed technology, reference is made to FIG. 2, which illustrates an example display tag 200. As will be understood and appreciated, the display tag 200 shown in FIG. 2 represents merely one approach or example of the disclosed technology, and other aspects can be used according to various aspects and/or examples of the disclosed technology.

The display tag 200 can be configured to suspend a product or a product packaging from any one of a plurality of hanging locations or objects. The product can be or include a promotional item, a specialty item, and/or any other particular item that can be displayed for sale. As described more fully herein, the display tag 200 can be configured to detachably attach to the product directly (or to the product packaging of the product) to thereby suspend the product via the display tag 200. For example, the display tag 200 can be positionable in a first orientation in which the product is configured to hang from a hanging display structure (e.g., a display shelf, a display hook, and/or any other similar structure). Alternatively or in addition, the display tag 200 can be positionable in a second, different orientation in which the product is configured to hang from a different object, such as from the packaging of a different product (e.g., the neck of a container). Accordingly, the display tag 200 can be convertible between the first orientation and the second orientation.

The display tag 200 can be or include a generally two-dimensional material that is cut to define the various components thereof. While the display tag 200 will have some amount of thickness, the thickness can be minimal (e.g., approximately 1 mm, approximately 2 mm, approximately 3 mm) when compared to the dimensions of the length (e.g., approximately 35 mm, approximately 40 mm, approximately 50 mm, approximately 60 mm, approximately 70 mm, approximately 80 mm, approximately 90 mm, approximately 100 mm, approximately 110 mm, approximately 120 mm, approximately 150 mm) and/or width length (e.g., approximately 35 mm, approximately 40 mm, approximately 50 mm, approximately 60 mm, approximately 70 mm, approximately 80 mm, approximately 90 mm, approximately 100 mm) of the display tag 200. Stated otherwise, the display tag 200 can be or include a substrate or body having card-like dimensions, and one or more components of the display tag 200 can be formed or defined by one or more corresponding cuts made into the substrate or body of the display tag.

The display tag 200 can be formed through additive manufacturing techniques, molding techniques, pressing techniques, stamping techniques, and/or any other appropriate manufacturing technique. The display tag 200 can be formed to include a body 201, which defines the general structure of the display tag 200 and that supports the various components of the display tag 200. The body 201 can have a generally rectangular outer shape, as illustrated. Alternatively, the body 201 can have any other desired shape (e.g., triangular, square, circular, any polygonal shape, etc.). The display tag 200 can be formed from (e.g., comprise) plastic, one or more natural materials, cardboard, card stock, paperboard, paper, metal, one or more polymers, one or more composite materials, any other material capable of supporting the weight of the hanging product 20 as it is suspended from a particular location via the display tag 200, and/or any combination thereof.

The display tag 200 can function as a single item configured to selectively hang a hanging product 20 from either the primary product 10 (e.g., the neck of a bottle) and/or a hanging display structure (e.g., a peg hook of a pegboard display, a wire rack display, a retail display). As such, the display tag 200 can reduce the necessity of stocking multiple different types of hang tags and/or maintaining multiple inventory entries (e.g., SKUs) for a single product that is presented both as a standalone product and as part of a product bundle, as non-limiting examples.

To facilitate hanging of a hanging product 20 from one of various locations, the display tag 200 can include one or more apertures extending completely through the body 201 of the display tag 200. The one or more apertures can at least partially receive a portion of a structure or object such that the hanging product 20 can be suspended from the structure or object via the display tag 200. The structure or other object can be or include an item that can at least partially insert into (e.g., insert through) at least one of the apertures of the display tag 200 and can support and suspend the hanging product 20 via the display tag 200. For example, the structure can include hanging display structure (e.g., a peg hook attached to a pegboard of a display rack of a retail store) and/or the neck of a container (e.g., the neck of a wine bottle).

The display tag 200 can include a first aperture 202 and a second aperture 203. The first aperture 202 can extend through the body 201 and can be located at a first end 221 of the body 201. The second aperture 203 can extend through the body 201 and can be located at a second end 222 of the body 201. The first end 221 can be located opposite the second end 222 (e.g., with respect to the flaps or any other attachment structure). The first aperture 202 can be smaller in size (e.g., diameter) than the second aperture 203. For example, the first aperture 202 can be sized and dimensioned to receive hanging display structure (e.g., a hook, a rod, and/or any other similarly shaped item, such as an item of a retail display rack, that can support and suspend the hanging product 20 and/or the display tag 200). Alternatively or in addition, the second aperture 203 can be sized and dimensioned to receive a neck or other component of a container (e.g., a different product 10, which can be a primary product 10 of a product bundle). For example, the second aperture 203 can at least partially receive the neck of the container (e.g., the neck of a wine bottle) such that the display tag 200 can be suspended from the container (and the hanging product 20 can be suspended therefrom via the display tag 200 to thereby present the hanging product as the secondary product 20 of the product bundle).

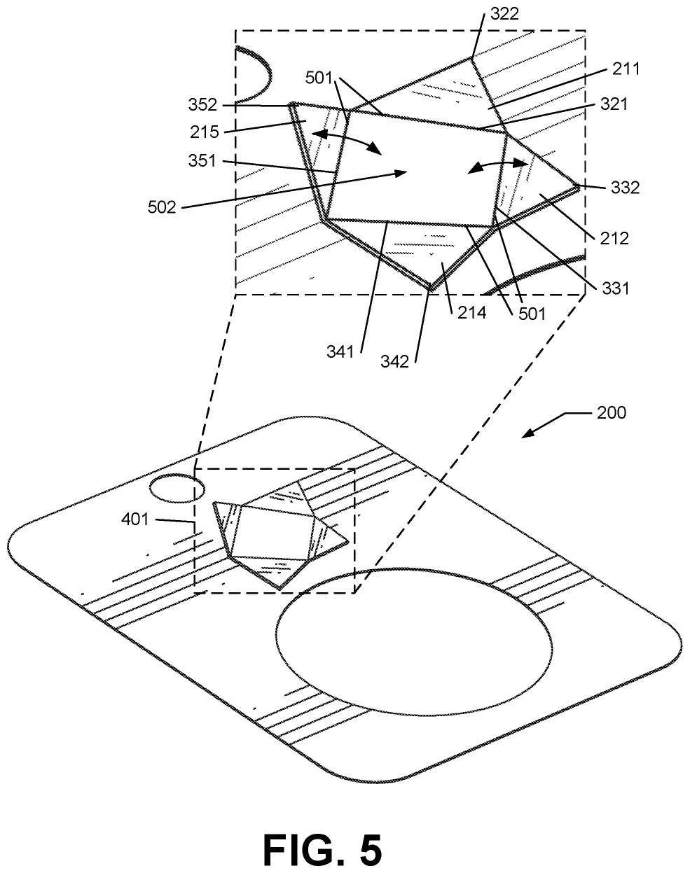

The display tag 200 can include a plurality of flaps. As illustrates, the display tag 200 can include a first flap 211 and a second flap 212, and the first and second flaps 211, 212 can be separated by a bridge 213. The first flap 211 and the second flap 212 can be positioned at a location between the first aperture 202 and the second aperture 203 (e.g., at a location along an imaginary line extending between the centers of the first aperture 202 and the second aperture 203). The bridge 213 can be a portion of material that maintains the continuity of the body 201 between fold lines of the first flap 211 and the second flap 212. The first flap 211 and the second flap 212 can cach be a partially cut-out portion of the body 201. The first flap 211 and the second flap 212 can extend from the bridge 213. The first flap 211 and the second flap 212 can be configured to fold outwardly (e.g., away from a plane defined by the top surface of the body 201) and/or inwardly (e.g., toward the plane defined by the top surface of the body 201). Thus, when folded inwardly to a non-extended position, the first flap 211 and the second flap 212 can be substantially even or substantially flush with the body 201. When folded outwardly to an extended position, the first flap 211 and the second flap 212 can be angled away from the body 201. For example, the first flap 211 and the second flap 212 can be substantially perpendicular to the body 201 when in a fully extended position. As discussed in further detail herein, though illustrated as having two flaps, the display tag 200 can include configurations with less than two flaps and/or configurations with greater than two flaps (e.g., as discussed in more detail with respect to FIGS. 5, 6, and 13A-13C).

The first flap 211 and the second flap 212 can fold outwardly to an extended position (e.g., a fully extended position) to thereby form an attachment structure that is detachably attachable to a product aperture of product packaging. For example, the attachment structure can be configured to extend through a product aperture of the hanging product 20 packaging. Once extended through the product aperture, the first flap 211 and the second flap 212 can be folded inwardly to thereby releasably secure the hanging product 20 to the display tag 200 via the connection of the display tag's 200 attachment structure (e.g., the first and second flaps 211, 212) and the hanging product's 20 product aperture. Once the display tag 200 is attached to the hanging product 20, the attachment structure can function as a pivot point for the display tag 200 to rotate relative to the hanging product 20. For example, the display tag 200 can rotate within the product aperture. By allowing the display tag 200 to freely rotate about the pivot point, the display tag 200 can be configured to transition between different orientations to thus selectively expose either the first aperture 202 (e.g., only the first aperture 202 and not the second aperture 203) or the second aperture 203 (e.g., only the second aperture 203 and not the first aperture 202). On exposing either the first aperture 202 or the second aperture 203, the display tag 200 can be configured to hang from any one of a plurality of different locations and/or structures.

Though illustrated as including only two apertures 202, 203, the display tag 200 can include any number of apertures distributed throughout the body 201 for hanging the display tag 200 from corresponding objects or locations. For example, a plurality of apertures (e.g., two, three, four, five, or more apertures) can each be differently sized and/or differently shaped. Each of the plurality of apertures can be located generally along a perimeter of the body 201. That is to say, each of the plurality of apertures can be positioned between the flaps (or any other attachment structure) and an edge of the body 201.

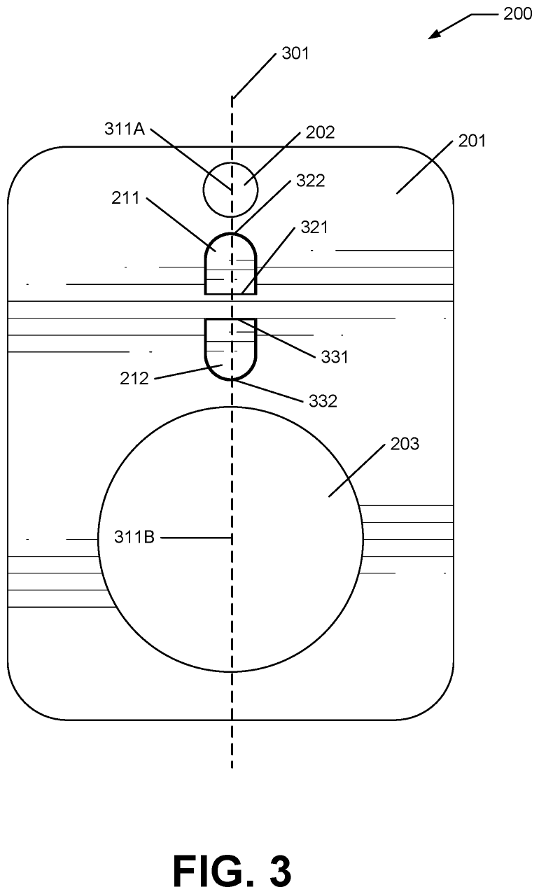

Referring now to FIG. 3, illustrated is a front view of the display tag 200, in accordance with the disclosed technology. The display tag 200 can include an imaginary line 301 extending through a first center point 311A of the first aperture 202 and a second center point 311B of the second aperture 203. The line 301 can extend through and symmetrically divide the display tag 200. The first flap 211 and the second flap 212 can extend parallel to the line 301. Alternatively or in addition, the first flap 211 and the second flap 212 can each have a corresponding central axis that is coincident upon the imaginary line 301. For example, the first flap 211 can include a proximal end 321 and a distal end 322, and the second flap 212 can include a proximal end 331 and a distal end 332. Either proximal end 321, 331 can refer to the end of the corresponding flap 211, 212 that is attached to the body 201, and either distal end 322, 332 can refer to the end of the corresponding flap 211, 212 that is free and detached from the body 201. Continuing this example, the line 301 can extend through the proximal end 321 and the distal end 322 of the first flap 211 and the proximal end 331 and the distal end 332 of the second flap 212. The first flap 211 and the second flap 212 can be oriented such that the distal end 322 of the first flap 211 is nearer the first aperture 202 than the proximal end 321 of the first flap 211 and the distal end 332 of the second flap 212 is nearer the second aperture 203 than the proximal end 331 of the second flap 212.

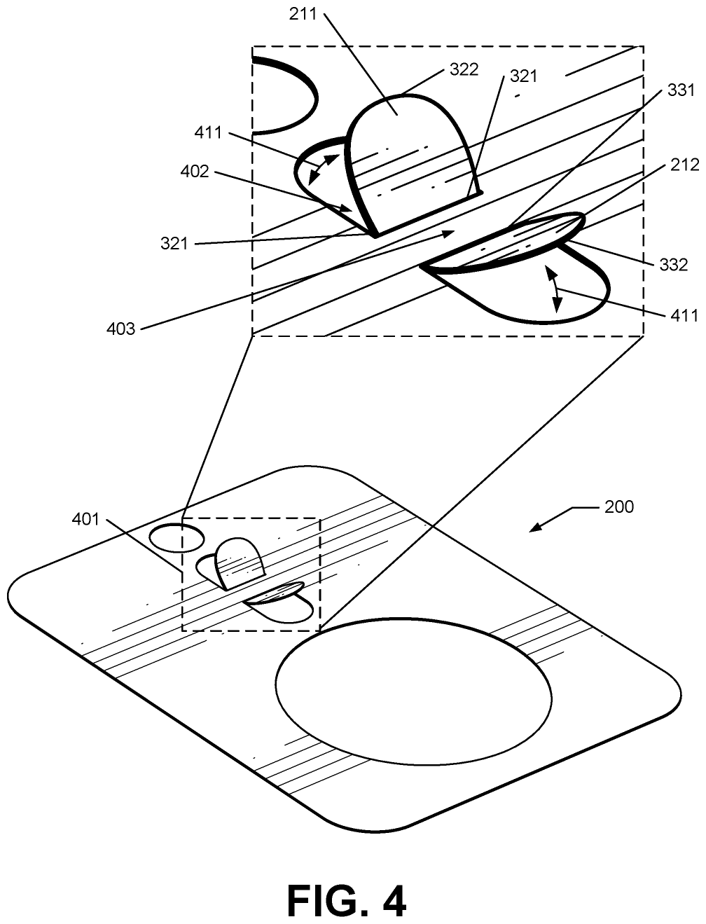

Referring now to FIG. 4, illustrated is an isometric view of the display tag 200 with the flaps 211, 212 folded to an intermediate position (or partially extended position) that is between the non-extended position (e.g., the flaps 211, 212 are substantially flush with the body 201) and the fully extended position (e.g., the flaps 211, 212 are substantially perpendicular to the body 201), in accordance with the disclosed technology. The first flap 211 and the second flap 212 can be configured to rotate relative to the plane of the body 201 and can rotate (or fold) toward a first side of the body 201 (e.g., the face) or a second side of the body 201 (e.g., the rear). The rotation 411 can define either an outward rotation or an inward rotation of the first flap 211 and the second flap 212. As will be appreciated by those having skill in the art, the first flap 211 and the second flap 212 can be configured to be folded to (or between) the non-extended position, the fully extended position, and a plurality of intermediate or partially extended positions. In addition, the first flap 211 and the second 212 can be configured to be folded beyond the fully extended position such that the front of the first and/or second flap 211, 212 faces the front of the body 201. The first flap 211 and the second flap 212 can be configured to be folded such that at least some of the front of the first and/or second flap 211, 212 contacts (or nearly contacts) the front of the body 201. As discussed herein, the first flap 211 and the second flap 212 can fold to a “locked position” in which the front of the first and/or second flap 211, 212 nearly contacts the front of the body 201 (e.g., the first and/or second flap 211, 212 can be substantially (and/or nearly) parallel to the body 201.

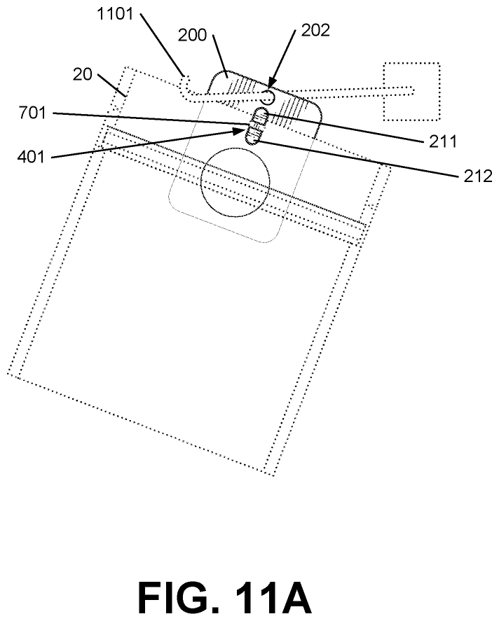

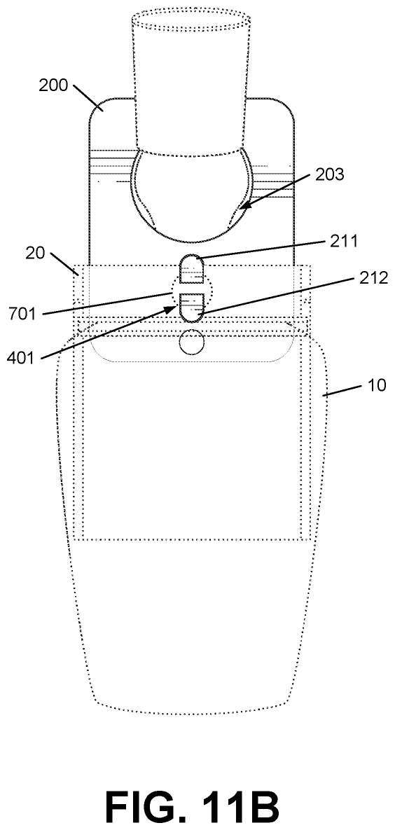

When extended to a partially extended position, the upper one of the first flap 211 or the second flap 212 can form a catch 402. The catch 402 can be defined by the attachment point between the proximal end 321, 331 of the upper one of the first flap 211 or the second flap 212 (e.g., at the transition from the corresponding flap 211, 212 and the bridge 213) and can form a structure that can suspend the hanging product 20 and can prevent the hanging product 20 from sliding apart from, or otherwise being disconnected from, the display tag 200. Stated otherwise, the catch 402 can function as an anchoring point for supporting the weight of a product packaging through its respective hang tag (see FIGS. 11A and 11B for further discussion).

The first flap 211 and the second flap 212 can perform the outward rotation to transition from the non-extended position to the extended position. When in the extended position, the first flap 211 and the second flap 212 can be substantially perpendicular to the body 201. The first flap 211 and the second flap 212 can form an attachment structure 401 (e.g., when in the extended position). As discussed in further detail herein, the attachment structure 401 can extend through the product aperture of the hanging product 20 and/or a hang tag attached to the hanging product 20. The attachment structure 401 can be, include, or form a pivot point 403 about which the display tag 200 can rotate relative to the hanging product 20 when the attachment structure 401 is attached to the hanging product 20.

Referring now to FIG. 5, illustrated is an isometric view of an example display tag 200 in the extended position, in accordance with the disclosed technology. As illustrated, the display tag 200 can include four flaps 211, 212, 214, 215, as a non-limiting example. The four flaps 211, 212, 214, 215 can cach be configured to rotate, similarly to the flaps 211, 212 previously described. Each of the flaps 211, 212, 214, 215 can include a proximal end 321, 331, 341, 351 and a distal end 322, 332, 342, 352. The proximal end 321, 331, 341, 351 of each flap 211, 212, 214, 215 can be at or near a fold line 501, and the distal ends 322, 332, 342, 352 of the flaps 211, 212, 214, 215 can meet at a central point of the attachment structure 401. Thus, when in the extended position, the flaps 211, 212, 214, 215 can “open” to form a central aperture 502 of the attachment structure 401.

When in the non-extended position, the front surface of each flap 211, 212, 214, 215 can be approximately even or flush with the front surface of the body 201. When rotating outwardly, the four flaps 211, 212, 214, 215 can rotate and/or fold about each respective fold line 501. When in the fully extended position, the flaps 211, 212, 214, 215 can be approximately perpendicular to the body 201, and the flaps 211, 212, 214, 215 can be configured to further fold outwardly to a locked position in which the front surface of each flap 211, 212, 214, 215 is facing the front surface of the body 201. As such, the flaps 211, 212, 214, 215 can be configured to fold outwardly to form the attachment structure 401, at least partially insert into a product aperture of a hanging product 20, and further fold outwardly to a locked position in which the front surface of each flap 211, 212, 214, 215 is facing the front surface of the body 201 (and/or a central aperture 502 of the attachment structure 401 is formed).

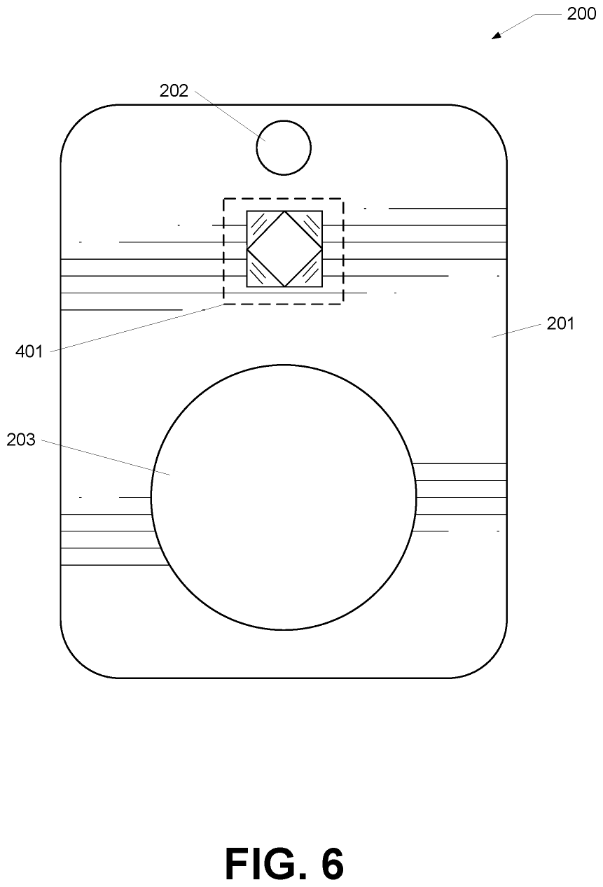

Referring now to FIG. 6, illustrated is a front view of the display tag 200, in accordance with the disclosed technology. As shown, the attachment structure 401 is in the locked position. The attachment structure 401 can be located between the first aperture 202 and the second aperture 203. The first aperture 202 and the second aperture 203 can be substantially similar to the first aperture 202 and the second aperture 203 of the display tag 200.

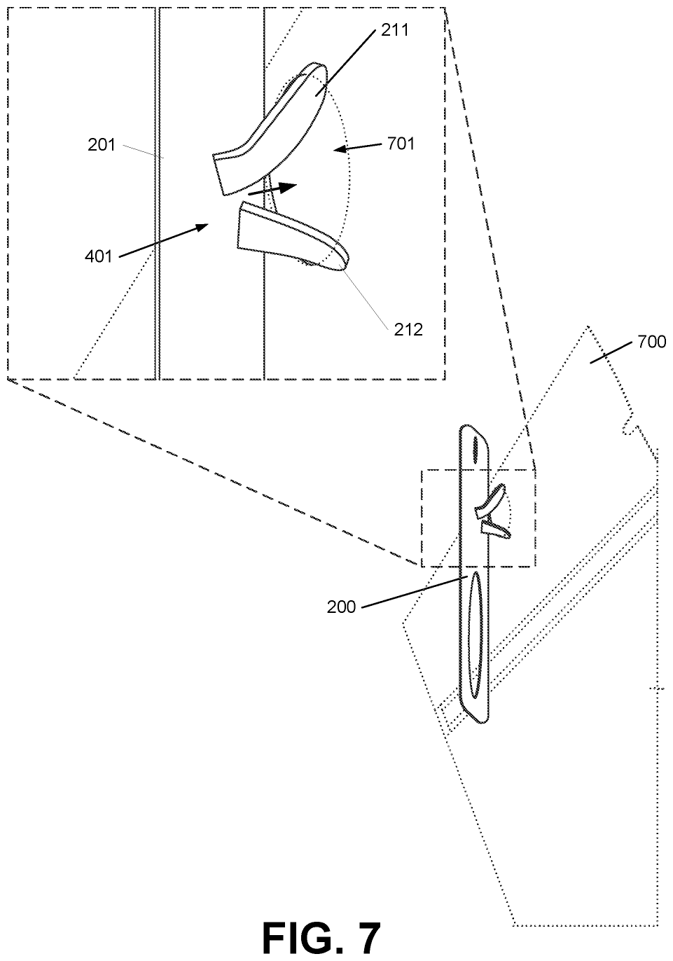

Referring now to FIG. 7, illustrated is the attachment structure 401 extending through a product aperture 701 of a product packaging 700 (also referenced herein as a hanging package), in accordance with the disclosed technology. The product packaging 700 can be or include any product or packaging thereof, particularly any item configured for display and sale in a retail store. Though illustrated in FIG. 7 as a bag, the product packaging 700 can include any product, package, packaging or the like. The product aperture 701 can be generally configured to receive, and hang from, hanging display structure (e.g., a shelf, a clip strip, a hook, or other display structure). The attachment structure 401 can be configured to insert into the and/or through the product aperture 701 and to thusly suspend the product packaging 700.

As discussed herein, the first flap 211 and the second flap 212 can fold outwardly from the non-extended position to the extended position to form the attachment aperture 401. The first flap 211 and the second flap 212 can fold outwardly to a sufficient degree (e.g., approximately perpendicular to the body 201) such that the attachment aperture 401 can extend through the product aperture 701. Once extended through the product aperture 701, the first flap 211 and the second flap 212 can fold inwardly toward the body 201 to transition from the fully extended position to a partially extended position. Once in the partially extended position, the attachment structure 401 can substantially secure the display tag 200 to the product packaging 700 via the product aperture 701 such that the display tag 200 can suspend the product packaging 700 via the attachment structure 401 and the product aperture 701. To detach the display tag 200 from the product packaging 700, the first and second flaps 211, 212 can be folded to the extended position and can be removed from the product aperture 701.

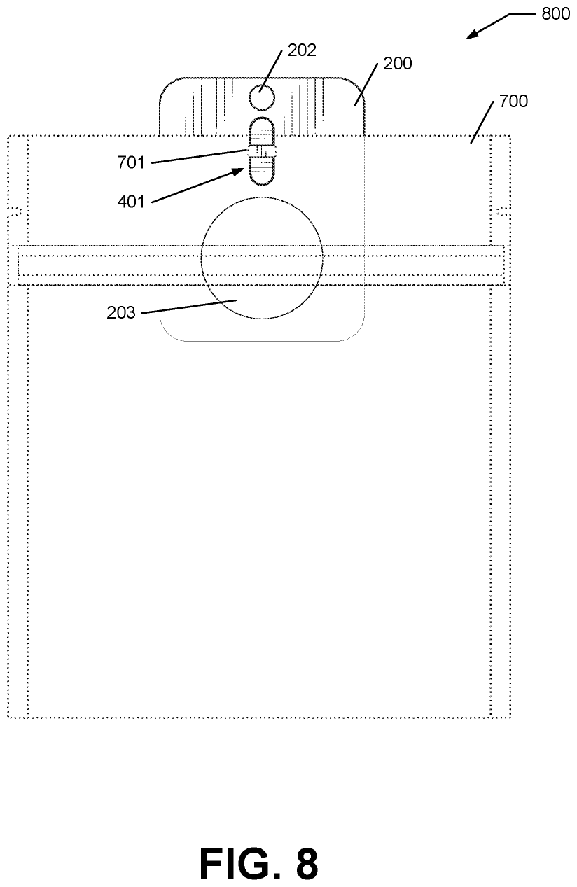

Referring now to FIG. 8, illustrated is the display tag 200 in a first orientation 800, in accordance with the disclosed technology. The display tag 200 can detachably attach to the product packaging 700 at the product aperture 701, as described herein. When affixed to the display tag 200, the product packaging 700 can suspend from the display tag 200. The first orientation 800 can comprise the first aperture 202 being positioned above the product packaging 700 when the display tag 200 is suspended from an object and the product packaging 700 is suspended from the display tag 200. When in the first orientation 800, the first aperture 202 can be visible above the product packaging 700 and the second aperture 203 can be hidden behind the product packaging 700. As such, the display tag 200 can at least partially receive a hanging display structure at the exposed first aperture 202.

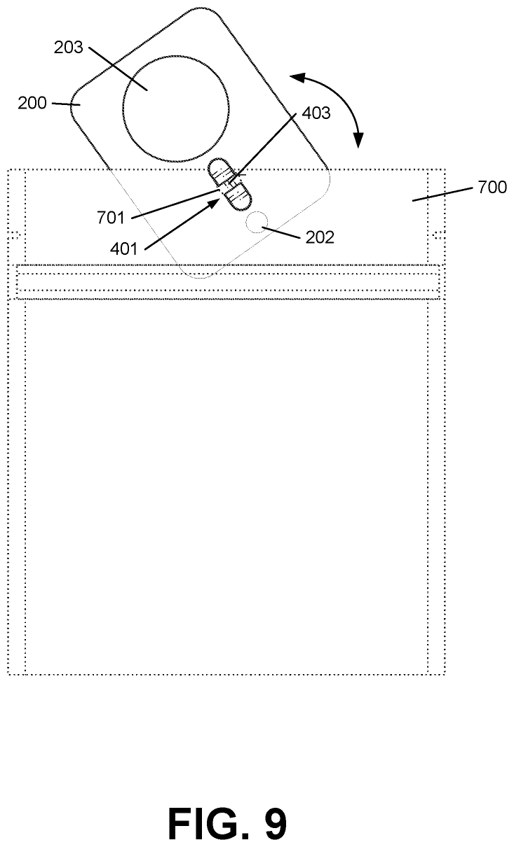

Referring now to FIG. 9, illustrated is the display tag 200 rotating about the pivot point 403, in accordance with the disclosed technology. The display tag 200 can rotate about the pivot point 403 while the product packaging 700 is attached to the product packaging 700. The display tag 200 can rotate about the pivot point 403 to transition between the first orientation 800 and a second orientation 1000. For example, the attachment structure 401 of the display tag 200 can rotate within the product aperture 701 and about the pivot point 403 to transition from the first orientation 800 to the second orientation 1000, and vice versa.

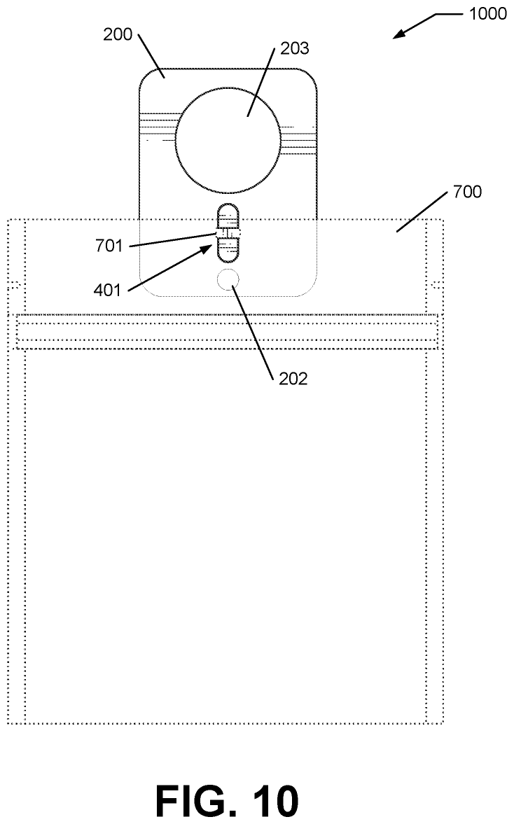

Referring now to FIG. 10, illustrated is the display tag 200 in the second orientation 1000, in accordance with the disclosed technology. When affixed to the display tag 200, the product packaging 700 can suspend from the display tag 200. The second orientation 1000 can comprise the second aperture 203 being positioned above the product packaging 700 when the display tag 200 is suspended from an object and the product packaging 700 is suspended from the display tag 200. When in the second orientation 1000, the second aperture 203 can be visible above the product packaging 700 and the first aperture 202 can be hidden behind the product packaging 700. As such, the second aperture 203 can at least partially receive a neck of a container (e.g., the neck of a wine bottle), and the display tag 200 can suspend the product packaging 700 from the container.

Referring now to FIGS. 11A and 11B, certain convertible and/or multi-purpose aspects of the disclosed technology are illustrated. For example, FIG. 11A illustrates a display tag 200 attached to a hanging product 20 (e.g., via the flaps 211, 212 and the hanging product's 20 product aperture). As illustrated, the first aperture 202 of the display tag 200 can at least partially receive a peg hook 1101 (or other hanging display structure). Accordingly, the hanging product 20 can be suspended from the peg hook 1101 via the display tag 200, and as such, the display tag 200 enables the hanging product 20 to be displayed for sale as a standalone item.

Continuing the example, and now referring in particular to FIG. 11B, the same display tag 200 can be attached to the hanging product 20 (e.g., via the flaps 211, 212 and the hanging product's 20 product aperture), and the second aperture 203 can at least partially receive a portion of a primary product 10. As illustrated in FIG. 11B, the second aperture 203 can at least partially receive the neck of a bottle. Accordingly, the hanging product 20 can be suspended from the primary product 10 via the display tag 200, and as such, the display tag 200 enables the hanging product 20 to be displayed for sale as part of a product bundle.

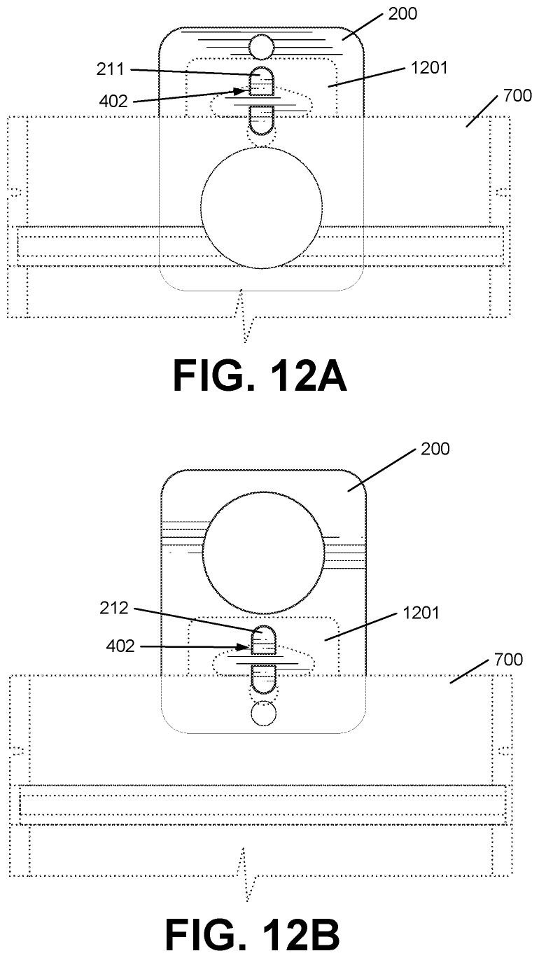

Referring now to FIGS. 12A and 12B, illustrated is a hang tag 1201 attached to product packaging 700 and the display tag 200 attached to the hang tag 1201 in either the first orientation 800 (see FIG. 12A) or the second orientation 1000 (see FIG. 12B). The hang tag 1201 can be adhered to the product packaging 700. The hang tag 1201 can suspend from the catch 402 of an upper flap 211, 212. The upper flap 211, 212 can be defined as the flap 211, 212 that is located above the other flap 211, 212 when the product packaging 700 is suspended from the display tag 200. For example, in the first orientation 800 shown in FIG. 12A, the first flap 211 is the upper flap. As another example, in the second orientation 1000 shown in FIG. 12B, the second flap 212 is the upper flap. The hang tag 1201 can suspend the product packaging 700 via the catch 402 by hooking to the catch 402. The display tag 200 can be rotated such that the hang tag 1201 can hang from the first flap 211 in the first orientation 800 or hang from the second flap 211 in the second orientation 1000.

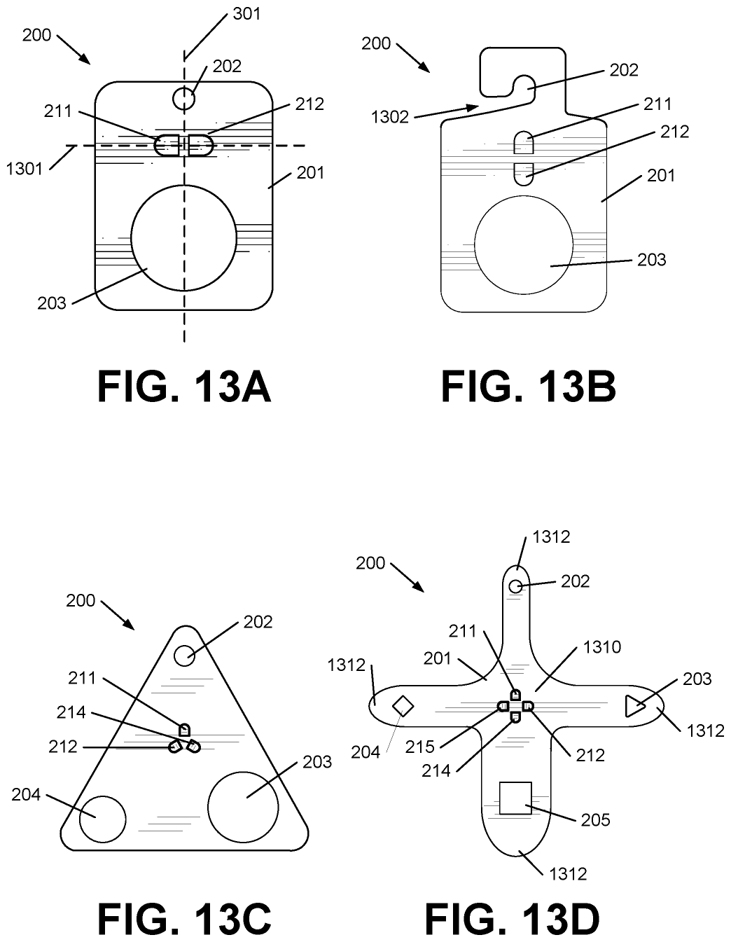

Throughout this disclosure, reference has been made to an example display tag 200 that, to this point, has been generally shown as having a body 201 that has a generally rectangular outer shape (e.g., a rectangle, a rectangle with rounded corners), a first aperture 202 having a generally circular shape, a second aperture 203 having a generally circular shape, and two opposing flaps 211, 212. However, the disclosed technology is not so limited. As non-limiting examples and referring now to FIGS. 13A-13D, the display tag 200 can have a body 201 that has any desired shape, can include apertures that have any desired shape or size, and can include any number of flaps (e.g., flaps 211, 212) arranged in any desired configuration.

As shown in FIG. 13A, the display tag 200 can have opposing flaps 211, 212 that are in a generally horizontal configuration. Stated otherwise, the display tag 200 can include a first imaginary line 301 extending through the center of the first aperture 202 and the center of the second aperture 203 (e.g., the first center point 311A and the second center point 311B, respectively, as discussed with respect to FIG. 3). The first imaginer line 301 can extend through and symmetrically divide the display tag 200, and the first flap 211 and the second flap 212 can extend substantially perpendicular to the first line 301. That is to say, the first flap 211 and the second flap 212 can each have a corresponding central axis that is aligned with and/or coincident upon a second imaginary line 1301, and the second imaginary line 1301 can be perpendicular (or approximately perpendicular) to the first imaginary line. As illustrated in FIG. 13A, the proximal ends 321, 331 of the flaps 211, 212 can be located nearer the first imaginary line 301 than the distal ends 331, 332. However, the disclosed technology is not so limited, and alternatively, the distal ends 331, 332 of the flaps 211, 212 can be located nearer the first imaginary line 301 than the proximal ends 321, 331.

Referring now to FIG. 13B, the first aperture 211 can be connected to a slot 1302 such that the first aperture is not necessarily fully surrounded by portions of the body 201.

Alternatively or in addition, the body 201 can have a generally triangular shape, as a non-limiting example, and the display tag 200 can include more than two apertures, such as the three apertures 202, 203, 204 shown in FIG. 13C.

Alternatively or in addition, the body 201 can have an irregular shape. For example, as shown in FIG. 13D, the body 201 can comprise a central portion 1310 and multiple lobes 1312 extending from the central portion 1310. The various lobes 1312 have the same size (e.g., length and/or width) and/or the same general shape. Alternatively, some or all of the lobes 1312 can have a different size and/or a different general shape. Each lobe 1312 can comprise a corresponding aperture. Each aperture can have the same shape but different sizes. Alternatively or in addition, each aperture can have the same size but different shapes. Alternatively or in addition, one, some, or all of the apertures can have a different size and/or a different shape as compared to the other apertures. As illustrated, a first aperture 202 can have a generally circular shape and a first size (e.g., surface area, length, width, diameter), a second aperture 203 can have a generally triangular shape and a second size that is greater than the first size, a third aperture 204 can have a generally diamond shape and a third size that is greater than the first size and/or the second size, and a fourth aperture 205 can have a generally square shape and a fourth size that is greater than the first size, the second size, and/or the third size.

The central portion 1310 can comprise one or more flaps, such as the three flaps 211, 212, 214 shown in FIG. 13C or the four flaps 211, 212, 214, 215 shown in FIG. 13D, as non-limiting examples. As described herein, the various flaps (e.g., flaps 211, 212, 214, and/or 215) can combine to form an attachment structure (e.g., attachment structure 401) and can be configured to at least partially insert into a product aperture or hang tab aperture, as non-limiting examples. In any event, the flaps can be configured to detachably attach the display tag 200 to a hanging product 20, as described herein.

The flaps (e.g., flaps 211, 212, 214, 215) can be arranged such that the proximal end (e.g., the fold line) of each flap is nearer to a central point between all flaps that the corresponding distal end of each flap. Alternatively, as discussed particularly with respect to FIGS. 5 and 6, the distal end of each flap can be located nearer to the central point than the proximal end of each flap. Alternatively or in addition, one or more flaps can have its proximal end nearer to the central point that its distal end, and one or more other flaps can have its distal end nearer to the central point than its proximal end.

Each flap (e.g., flap 211, flap 212, flap 214, flap 215) can have any desired shape, such as a generally semi-obround shape (e.g., half of a pill shape, half of a stadium), a generally triangular shape, a generally rectangular shape, a generally square shape, a generally semi-circular shape, or the like. The flaps can all have the same shape, or one, some, or all of the flaps can have a different shape.

In any event, the flaps can form an attachment structure 401 that can at least partially insert into a product aperture of a hanging product 20 (or otherwise attach to the hanging product 20) such that the hanging product 20 can be suspended from the display tag 200 via the attachment structure 401 and the display tag 200 can rotate relative to the hanging product 20 (e.g., about a pivot point at the attachment structure 401 and the product aperture of a hanging product 20).

Alternatively or in addition, the display tag 200 can omit the second aperture 203 (or the first aperture 202). For example, the display tag 200 can have an end (or lobe 1312) that does not include an aperture, and instead, that portion (e.g., the portion of display tag 200's body 201 that is otherwise shown herein as including the now-omitted aperture) can include printed information (e.g., product information, marketing information, logos, images, coupon information, a QR code) or any other information displayed thereon. As a more specific example, the display tag 200 can include the first aperture 202 located at the or near the first end 221 of the body, and the second end 222 of the body 201 can omit any apertures but can instead include printed information displayed thereon.

Alternatively or in addition, the display tag 200 can include first printed information located proximate to (e.g., above, below, beside, around) the first aperture 202 and can include second printed information that is different from the first printed information and is located proximate to (e.g., above, below, beside, around) the second aperture 203. The first printed information can be positioned such that it is visible only when the display tag 200 is positioned in the first orientation 800 (e.g., the second printed information is hidden behind the hanging product 20 when the, and the second printed information can be positioned such that it is visible only when the display tag is positioned in the second orientation 1000. Stated otherwise, second printed information can be positioned such that it is hidden behind the hanging product 20 when the display tag 200 is positioned in the first orientation 800, and the first printed information can be positioned such that it is hidden behind the hanging product 20 when the display tag 200 is positioned in the second orientation 1000. Accordingly, and as a non-limiting example, the display tag 200 can be configured to display information germane to the hanging product 20 when (e.g. only when) being sold as a standalone product, and/or the display tag 200 can be configured to display information germane to the hanging product 20 when (e.g. only when) being sold as part of a product bundle (e.g., by including information about the primary product 10).

The foregoing description of the present articles of manufacture, systems, and processes have been presented only for the purposes of illustration and description and is not intended to be exhaustive or to limit the innovations to the precise forms disclosed. Many modifications and variations are possible in light of the above teaching.

The examples of the present articles of manufacture, systems, and processes were chosen and described in order to explain the principles of the claimed innovations and their practical application so as to enable others skilled in the art to utilize the innovations and various examples with various modifications as are suited to the particular use contemplated. Alternative examples of the disclosed technology will become apparent to those skilled in the art to which the claimed innovations pertain without departing from their spirit and scope. Accordingly, the scope of the claimed innovations is defined by the appended claims rather than the foregoing description and the examples described therein.

What is claimed is:

1. A display tag comprising:
a body comprising:
a first aperture located at a first end of the body;
a second aperture located at a second end of the body; and
a plurality of flaps located between the first end and the second end, wherein each of the plurality of flaps is configured to fold outwardly such that the plurality of flaps combine to form an attachment structure that is detachably attachable to a product aperture of a product packaging.

2. The display tag of claim 1, wherein the first aperture is smaller than the second aperture.

3. The display tag of claim 1, wherein the first aperture is configured to receive a peg hook.

4. The display tag of claim 1, wherein the second aperture is configured to receive a neck of a container.

5. The display tag of claim 1, wherein the body has a generally rectangular outer shape.

6. The display tag of claim 1, wherein:
each of the plurality of flaps comprises a distal end and a proximal end, wherein the distal end and the proximal end are positioned along an imaginary line extending through the first aperture and the second aperture;
one of the plurality of flaps comprises an upper flap configured to partially fold outwardly to create a catch at the proximal end of the upper flap; and
the catch is configured to at least partially receive a portion of a hang tag of the product packaging such that the product packaging is suspended from the catch.

7. The display tag of claim 1, wherein:
each of the plurality of flaps comprises a central longitudinal axis coincident upon a first imaginary line;
a second imaginary line extends through the first aperture and the second aperture; and
the first imaginary line is approximately perpendicular to the second imaginary line.

8. The display tag of claim 1, wherein the attachment structure defines a pivot point about which the display tag can rotate relative to the product packaging.

9. The display tag of claim 8, wherein the display tag is configured to rotate about the pivot point between a first orientation and a second orientation, the first orientation comprising the first aperture being located above the product packaging when the product packaging is suspended from the display tag.

10. The display tag of claim 8, wherein the display tag is configured to rotate about the pivot point between a first orientation and a second orientation, the second orientation comprising the second aperture being located above the product packaging when the product packaging is suspended from the display tag.

11. The display tag of claim 1, wherein:
each flap of the plurality of flaps is defined by a portion of material partially cut out from the body;
the body includes a bridge of material disposed between adjacent flaps of the plurality of flaps, the bridge having a first side and second side; and
the plurality of flaps comprises (i) a first flap extending from a first side of the bridge and configured to fold outwardly along the first side and (ii) a second flap extending from a second side of the bridge and configured to fold outwardly along the second side.

12. The display tag of claim 1, wherein each flap of the plurality of flaps is configured to fold outwardly to a fully extended position comprising the corresponding flap being approximately perpendicular to the body.

13. The display tag of claim 12, wherein:
each of the plurality of flaps is configured to fold outwardly between a non-extended position and the fully extended position;
the attachment structure is configured to extend through the product aperture; and
each of the plurality of flaps is configured to fold inwardly from the fully extended position to a partially extended position to thereby secure the display tag to the product packaging.

14. The display tag of claim 1, wherein the display tag is configured to suspend the product packaging via the attachment structure.

15. The display tag of claim 1, wherein:
each of the plurality of flaps is configured to extend from the body and comprises a distal end and a proximal end, wherein the distal end is located at a tip of a corresponding flap of the plurality of flaps and the proximal end is located at a fold line of the corresponding flap of the plurality of flaps;
each of the plurality of flaps is configured to fold outwardly along the fold line to thereby diverge the tips away from a central point; and
each of the plurality of flaps is configured to fold inwardly along the fold line to thereby converge the tips at the central point.

16. The display tag of claim 1, wherein the body further comprises cardboard, paper, plastic, metal, polymer, or a combination thereof.

17. A method comprising:
folding a plurality of flaps outwardly from a body of a display tag to thereby form an attachment structure, wherein the display tag comprises (i) a first aperture located at a first end of the body, (ii) a second aperture located at a second end of the body, and (iii) the plurality of flaps, wherein the plurality of flaps is positioned at a location between the first aperture and the second aperture;
inserting the attachment structure through a packaging aperture of a product packaging;
folding the plurality of flaps to a locked position, thereby affixing the display tag to the product packaging; and
hanging the product packaging via the display tag by:
rotating the display tag about the attachment structure to a first orientation in which the first aperture is located above the product packaging and attaching the display tag to a peg hook via the first aperture to thereby suspend the product packaging from the peg hook; or
rotating the display tag about the attachment structure to a second orientation in which the second aperture is located above the product packaging and attaching the display tag to a neck of a container via the second aperture to thereby suspend the product packaging from the neck of the container.

18. An assembly comprising:
a display tag comprising:
a body comprising:
a first aperture located at a first end of the body;
a second aperture located at a second end of the body, the second aperture being larger than the first aperture; and
a plurality of flaps located between the first end and the second end, wherein each of the plurality of flaps is configured to fold outwardly such that the plurality of flaps combine to form an attachment structure that is detachably attachable to a product aperture of a product packaging;
the product packaging comprising the product aperture, wherein the plurality of flaps at least partially extends through the product aperture to thereby attach the display tag to the product packaging; and
a container comprising a neck, wherein the neck at least partially extends through the second aperture.

19. The assembly of claim 18, wherein the first aperture is configured to receive at least a portion of a peg hook.

20. The assembly of claim 18, wherein the plurality of flaps is configured to rotatably attach the display tag to the product packaging.
